(19) United States
(12) Patent Application Publication
(10) Pub. No.: US 2004/0073919 A1
(43) Pub. Date: Apr. 15, 2004

(54) Commercial recommender

(76) Inventors: Srinivas Gutta, Yorktown Heights, NY (US); Lalitha Agnihotri, Fishkill, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/255,842

(22) Filed: Sep. 26, 2002

(51) Int. Cl. H04N 7/16; H04H 9/00; H04N 7/025; H04N 7/10

(52) U.S. Cl. 725/35; 725/34; 725/9

(57) ABSTRACT

System and method for recommending commercials are disclosed. Commercials from video signals are identified and extracted. Transcript information about the identified commercials are learned and extracted. Each commercials are then classified into different categories according to their transcript information. User preferences to the commercials are determined. The commercials with the user preferences are then used to build or train a decision tree in order to select commercials to recommend to the user. The selected commercials are then recommended using a personal channel.

### BACKGROUND

1. Technical Field

The present invention relates to recommending commercials to viewers based on the viewers' preferences and commercial content.

2. Description of Related Art

Television commercials provide an effective way for television watchers to keep themselves aware of latest products, programs, etc. To this end, many different systems have been developed for recommending commercials to viewers. For example, U.S. Pat. No. 6,177,931 describes creating a viewer profile so that the profile could be used to customize the electronic program guide (“EPG”). The viewer profile is learned by gathering statistics about how the user interacts with the system. The built profile is then used to place advertisements at an appropriate place on the EPG. This patent, however, does not use the content of the commercials to build the profile. WO 00/49801 uses demographic and geographic information to recommend commercials of possible interest to the user.

Although these patents disclose recommending commercials, they do so by gathering information about the user or how the user interacts with the television. The primary disadvantage of doing this is that such systems would not be able to accurately suggest commercials of interest to the user. Accordingly, there is a need for a system that can automatically recommend commercials of interest to viewers more accurately based on the content of the commercial.

### SUMMARY

There is provided a commercial recommender for recommending commercials to users based on content. In one aspect, a method for recommending commercials comprises identifying commercial segments from video signals. Descriptive information from these commercial segments are then extracted. Based on the descriptive information and user's preferences, for example, from user's viewing history, commercials of interest are selected, for example, using a decision tree, for recommending to the user. The recommended commercials then may be presented to the user, for example, using a dynamic channel creation.

In another aspect, the system for recommending commercials includes a processor that controls a commercial detector module for detecting commercials and a module that extracts descriptive information from the detected commercials. The extracted information in the detected commercials are input to a recommender module that determines which commercials should be recommended to a user. The selected commercials for recommendation are then presented to the user via a dynamic channel creation module.

### BRIEF DESCRIPTION OF THE DRAWINGS

FIG. 1 is a flow diagram illustrating the method for recommending commercials in one aspect of the present invention.

FIG. 2 is a flow diagram illustrating a method for identifying or detecting commercials in video signals.

FIG. 3 is a flow diagram illustrating a method for extracting descriptive information from the identified video content.

FIG. 4 is a flow diagram illustrating a method for selecting commercials for recommendation.

FIG. 5 is a flow diagram illustrating dynamic channel creation for presenting recommended commercials to users.

FIG. 6 is a system diagram illustrating the components of the present invention in one aspect.

### DETAILED DESCRIPTION

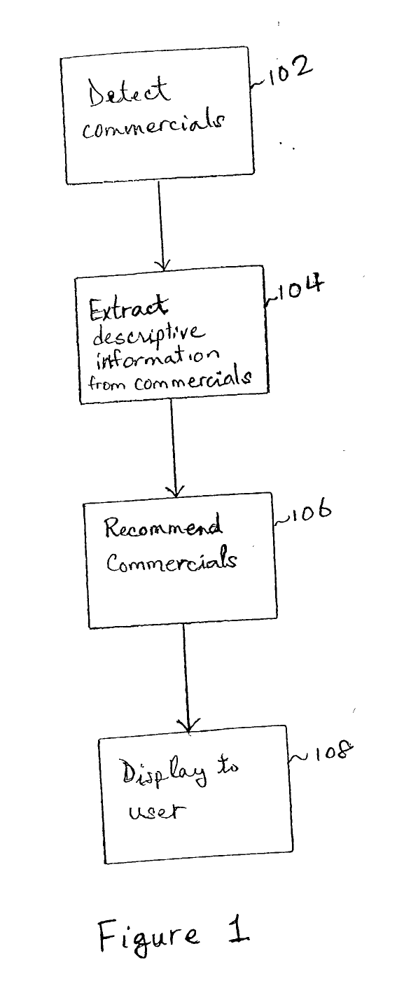

FIG. 1 is a flow diagram illustrating the method for recommending commercials in one aspect of the present invention. At 102, commercials are detected from a video signal. Generally, commercials in broadcasted video signals may be identified and extracted from other program segments. For example, U.S. patent application Ser. No. 09/417,288 entitled “AUTOMATIC SIGNATURE-BASE SPOTTING, LEARNING AND EXTRACTING OF COMMERCIALS AND OTHER VIDEO CONTENT,” (Nevenka Dimitrova et al., Attorney Docket No. PHA 23-803) filed on Oct. 13, 1999, and assigned to the instant assignee in the present application, which application is incorporated by reference herein in its entirety, describes improved techniques for spotting, learning, and extracting commercials or other particular types of video content in a video signal.

At 104, from the detected commercials, descriptive information is extracted. U.S. patent application Ser. No. 09/945,871 assigned to the instant assignee and entitled “A METHOD OF USING TRANSCRIPT DATA TO IDENTIFY AND LEARN COMMERCIAL PORTIONS OF A PROGRAM” (Lalitha Agnihotri et al., Attorney Docket No. US010338, filed on Sep. 4, 2001) discloses an example of extracting descriptive information from commercial portion of video signals. That application is incorporated herein in its entirely by reference thereto.

As described in that application, commercials may be grouped into different categories, for example, automobile, household goods, etc. Based on the descriptive content of the commercials, user preferred commercials may then be recommended to the users at 106. For example, U.S. patent application Ser. No. 09/466,406, entitled “METHOD AND APPARATUS FOR RECOMMENDING TELEVISION PROGRAMMING USING DECISION TREES,” (Srinivas Gutta, Attorney Docket No. PHA 23-902, filed on Dec. 17, 1999) and assigned to the assignee in the instant application, discloses an example of a method for recommending programs. The same method described therein may be applied to recommend commercials. That application is incorporated herein in its entirely by reference thereto.

The recommended commercials may be displayed by creating a personal channel so that the commercials of interest may be displayed to the user at 108. For Example, U.S. patent application Ser. No. 09/821,059, entitled “DYNAMIC TELEVISION CHANNEL CREATION,” (Srinivas Gutta et al., Attorney Docket No. US010074, filed on Mar. 29, 2001) and assigned to the assignee in the instant application, discloses providing a channel for displaying recommended programs. That application is incorporated herein in its entirely by reference thereto. Recommended commercials may be presented or displayed to the user in the similar manner described in that application.

Commercials may be detected from video signals received via one or more video sources such as a television receiver, a VCR or other video storage device, or any other type of video source. The source(s) may alternatively include one or more network connections for receiving video from a server or servers over, e.g., a global computer communications network such as the Internet, a wide area network, a metropolitan area network, a local area network, a terrestrial broadcast system, a cable network, a satellite network, a wireless network, or a telephone network, as well as portions or combinations of these and other types of networks. The commercials may be received via devices such as a television, a set-top box, a desktop, laptop or palmtop computer, a personal digital assistant (PDA), a video storage device such as a video cassette recorder (VCR), a digital video recorder (DVR), a TiVO device, etc., as well as portions or combinations of these and other devices.

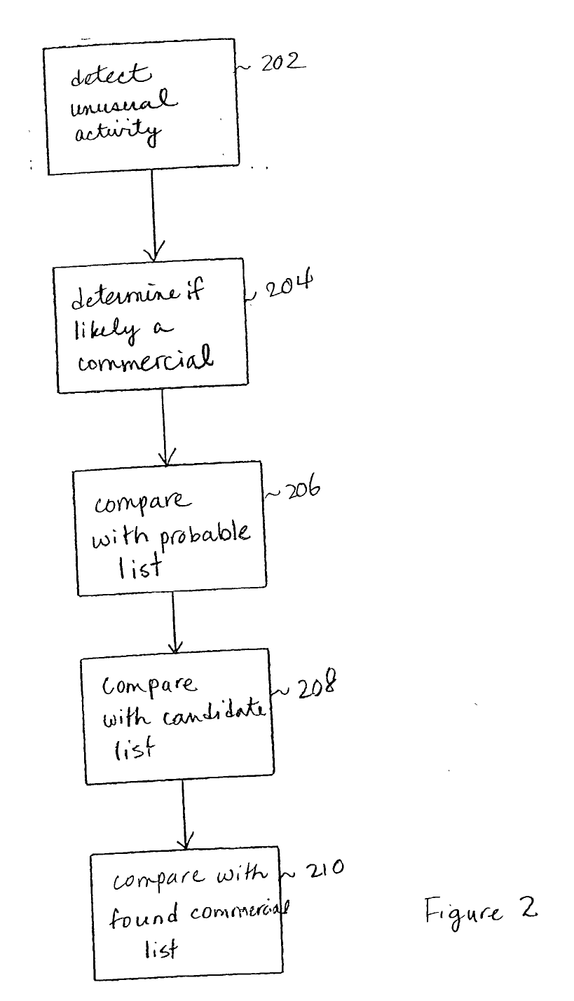

FIG. 2 illustrates an example of a process for spotting, learning and extracting commercials from a broadcast video signal in accordance with the invention. It is assumed for this example that the input video comprises a broadcast video signal including at least one program and multiple commercials.

Steps 202 through 210 are repeated while there is input video signal. At 202, unusual activity segments in the broadcast video signal is detected. This may involve, e.g., detecting a high cut rate area in the broadcast video signal, or detecting an area of high text activity. Other examples include detecting a fast change in the visual domain by accumulating color histograms, detecting a rise in the audio level, or detecting fast changes in the audio from music to speech, from one rhythm to another, etc.

At 204, the segments identified in step 202 as including unusual activity are further processed to determine if they are likely to be associated with a commercial. The segments so determined are then marked. Examples of features that may be used in making this determination include:

(a) Displayed text corresponding to entries in a stored text file of known company names, product or service names, 800 numbers or other telephone numbers, uniform resource locators (URLs), etc. that are associated with commercials.

(b) Speech. In this case, the speech may be extracted, converted to text and the resulting text analyzed against the above-noted stored text file to detect known company names, product or service names, 800 numbers or other telephone numbers, URLs, etc.

(c) Absence of closed caption information combined with a high cut rate.

(d) Closed caption information containing multiple blank lines.

(e) Completion of ending credits for a movie, show or other program.

(f) Average keyframe distance or average cut frame distance trend, e.g., an increasing or decreasing trend.

(g) Absence of logos, e.g., superimposed video logos identifying the broadcaster.

(h) Different font types, sizes and colors for superimposed text.

(i) Rapid changes in color palette or other color characteristic.

Signatures are then extracted from keyframes in the marked segments and placed in a particular “probable” list of signatures. The term “keyframe” as used herein refers generally to one or more frames associated with a given shot or other portion of a video signal, e.g., a first frame in a particular shot. Examples of probable lists of signatures are referred to as the lists L1, Li, Ln, etc. During a first pass through step 202, a given one of the probable lists will generally include signatures for multiple commercials as well as for portions of the program.

A given signature may be based on, e.g., a visual frame signature or an audio signature, or on other suitable identifying characteristics. A visual frame signature can be extracted using, e.g., an extraction method based on DC and AC coefficients (DC+AC), an extraction method based on DC and motion coefficients (DC+M), or other suitable extraction methods, e.g., methods based on wavelets and other transforms.

The above-noted DC+AC method is well known to those skilled in the technological art, and may be used to generate a visual frame signature comprising, e.g., a DC coefficient and five AC coefficients.

As another example, the above-noted DC+M method may be used to generate a set of signatures of the form (keyframe1, signature1, keyframe2, signature2, etc.). This DC+M extraction method is described in greater detail in, e.g., U.S. Pat. No. 5,870,754 issued Feb. 9, 1999 in the name of inventors N. Dimitrova and M. Abdel-Mottaleb, and entitled “Video Retrieval of MPEG Compressed Sequences Using DC and Motion Signatures,” and N. Dimitrova and M. Abdel-Mottaleb, “Content-Based Video Retrieval By Example Video Clip,” Proceedings of Storage and Retrieval for Image and Video Databases V, SPIE Vol. 3022, pp. 59-70, San Jose, Calif., 1997.

Other visual frame signature extraction techniques may be based at least in part on color histograms, as described in, e.g., N. Dimitrova, J. Martino, L. Agnihotri and H. Elenbaas, “Color Super-histograms for Video Representation,” IEEE International Conference on Image Processing, Kobe, Japan 1999.

An audio signature Ai may comprise information such as pitch (e.g., maximum, minimum, median, average, number of peaks, etc.), average amplitude, average energy, bandwidth and mel-frequency cepstrum coefficient (MFCC) peaks. Such a signature may be in the form of, e.g., a single object Al extracted from the first 5 seconds from a commercial. As another example, the audio signature could be a set of audio signatures {A1, A2, . . . An} extracted from, e.g., a designated time period following each identified cut.

The invention can also utilize numerous other types of signatures. For example, another type of signature may be in the form of closed caption text describing an advertised product or service. As another example, the signature could be in the form of a frame number plus information from a subimage of identified text associated with the frame, such as an 800 number, company name, product or service name, URL, etc. As yet another example, the signature could be a frame number and a position and size of a face or other object in the image, as identified by an appropriate bounding box. Various combinations of these and other types of signatures could also be used.

At 206, whenever a new potential commercial segment is detected, the signature of that segment is compared with the other signatures on the probable lists. If the new signature does not match any signature already on one of the probable lists, then the new signature is added to a probable list. If the new signature matches one or more signatures on one of the probable list, then the one or more matching signatures are placed in a particular “candidate” list of signatures. Examples of candidate lists of signatures are designated as lists C1, Cj, Cm, etc.

It should be noted that if the new signature is not similar to any signature for a segment more than about 30 seconds or less than about 10 minutes prior in time, but is similar to a signature for a segment about 10-13 minutes prior in time, there is an increased likelihood that it may be part of a commercial. In other words, this temporal relationship between similar signatures reflects the fact that a given probable list may include commercial segments spaced a designated approximate amount of time apart, e.g., 10 minutes apart. This temporal spacing relationship may be determined experimentally for different types of programs, broadcast time slots, countries, etc.

Other types of temporal or contextual information may be taken into account in the comparison process. For example, if a particular signature appears in approximately the same time slot on one day as it did on a previous day, it may be more likely to be associated with a commercial. The lists may also be divided into different groups for different day, time or channel slots so as to facilitate the comparison process. For example, shows for children are generally run during early morning time slots and would most likely have different commercials than an evening program such as Monday Night Football. An electronic programming guide (EPG) may be used to provide this and other information. For example, a signature could be associated with a particular show name and rating, resulting in an arrangement such as (show name, rating, channel, keyframe1, signature, keyframe5, signature, etc.). Program category information from the EPG may also be used to help in identifying commercials in the lists.

At 208, whenever a new potential commercial segment is detected, the signature of that segment is also compared with the signatures on the above-noted candidate lists. If the new signature matches a signature on one of the candidate lists, the new signature is moved to a particular “found commercial” list, also referred to herein as a permanent list. Examples of found commercial lists are the lists P1 and Pk.

At 210, if there is at least one signature on a given found commercial list, the signature of any new potential commercial segment is first compared to the signature(s) on that list. If a match is found, a commercial frequency counter associated with the corresponding signature is incremented by one. If there is no match with a signature on a found commercial list, the new signature is then compared with the signatures on one or more of the candidate lists. If a match is found for the new signature on a given one of the candidate lists, the new signature is placed on a commercial found list as per step 208. If there is no match with any signature on a candidate list, the new signature is placed on one of the probable lists.

The above-noted counter for the signatures on a found commercial list can be monitored to determine how frequently it is incremented, and the results used to provide further commercial identification information. For example, if the counter is incremented within a relatively short period of time, on the order of about 1-5 minutes, it is probably not a commercial. As another example, if the counter is not incremented for a very long time, e.g., on the order of a week or more, then the counter may be decremented, such that the commercial is eventually “forgotten” by the system. This type of temporal relationship policy can also be implemented for the signatures on the above-noted probable lists. Advantageously, the invention allows the identification and extraction of particular video content. According to this method, content and types of commercials may be identified. Details of the method are further described in the co-pending, co-owned, U.S. patent application Ser. No. 09/417,288, disclosed above.

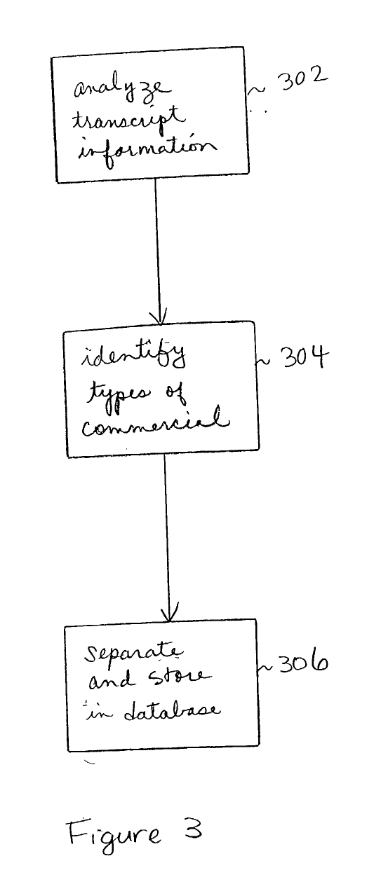

FIG. 3 is a flow diagram illustrating a method for extracting descriptive information from the identified video content as described above with reference to FIG. 2. Typically, advertisers want to deliver their message in a relatively short period of time. This leads to the product name, company name, and other identifying features being repeated frequently during a commercial broadcast. Accordingly, in one aspect, commercial portions of a broadcast program, for example, identified as described above with reference to FIG. 2, may be learned, for example, by analyzing the transcript information such as close captioning associated with each commercial portion.

Accordingly, at 302, the transcript information associated with the commercial portion is analyzed for specific words and features. For example, transcript information may be used to identify individual types of commercials by detecting frequently occurring words at 304. Based on analysis of actual broadcast commercials, the inventors have determined that if a non-stop word occurs at least three times within a pre-determined time period (15 seconds), this is indicative of the occurrence of a commercial. Non-stop words are words other than “an”, “the”, “of”, etc. The inventors have discovered that it is unlikely that a non-stop word would occur in a non-commercial portion of a program more than three times during any 15 second interval.

The following text is the closed-captioned text extracted from the Late-Night Show with David Letterman which includes two commercials.

| | |
|---|---|
| 1367275 | I'll tell you what, ladies and |
| 1368707 | gentlemen, when we come back |
| 1369638 | we'll be playing here. |
| 1373975 | (Cheers and applause) |
| 1374847 | (band playing) of using a dandruff shampoo |
| 1426340 | Note how isolated it makes people feel. |
| 1430736 | Note its unpleasant smell, the absence of rich lather. |
| 1433842 | Note its name. Nizoral a-d. |
| 1437276 | The world's #1 prescribed ingredient for dandruff . . . |
| 1440019 | In non-prescription strength. |
| 1442523 | People can stay dandruff free by doing this with nizoral a-d |
| 1444426 | only twice a week. |
| 1447560 | Only twice a week. What a pity. |
| 1449023 | Nizoral a-d; |
| 1451597 | I see skies of blue |
| 1507456 | and clouds of white |
| 1509419 | the bright, blessed day |
| 1512724 | the dogs say good night |
| 1515728 | and i think to myself . . . |
| 1518432 | Discover estee lauder pleasures |
| 1520105 | and lauder pleasures for men. |
| 1521937 | Pleasures to go. For her. |
| 1524842 | For him. |
| 1526674 | Each set free with a purchase |
| 1527806 | of estee lauder pleasures |
| 1528947 | of lauder pleasures for men. |
| 1530450 | . . . Oh, yeah. |
| 1532052 | |
| 1534155 | |
| 1566922 | (Band playing) |
| 1586770 | >>dave: It's flue shot Friday. |
| 1587572 | You know, I'd like to take a |
| 1588473 | minute here to mention the . . . |

The closed-captioning text demonstrates the effectiveness of the invention wherein the words “Nizoral”, “A-D”, “dandruff”, and “shampoo” appeared at least three times during the first commercial (15 second) segment between time stamps 1374847 and 1449023. Morover, the words “lauder” and “pleasures” appeared more than three times in the second commercial between time stamps 1451597 and 1528947. This is based on the fact that advertisers want to deliver their message in a short period of time and therefore must frequently repeat the product name, company and other identifying features of the product to the audience to convey the desired message and information in a short period of time. By detecting the occurrence of these non-stop words in the transcript information in a predetermined time period, individual commercials can be learned and separated from each other.

The types of individual commercials, for example, shampoo or perfume, may be learned and grouped into categories by using, for example, an approximate matching technique such as approximate string matching “Shift-Or Algorithm.” This algorithm is well known to those skilled in the technological art. The “Shift-Or-Algorithm” accounts for spurious characters (words, phrases, sentences) that may be introduced into the text due to multiple sources from where the transcript text is obtained or generated.

Once types of individual commercials have been identified, transcript information corresponding to each commercial along with the commercial may be stored in a database at 306, for example, indexed by commercial types. Such storing of information provides a search mechanism for searching for a particular commercial in the database, for example, so particular advertisements may be searched for and retrieved to present the user with commercials which match the user's requirements. For example, the database may be searched to retrieve commercials related to a particular type of commercial (auto) or a commercial for a particular product (Honda Accord). The database would include the type of the commercial and any additional identifying features as well as the commercial itself. Further details of this method is described fully in co-pending U.S. patent application Ser. No. 09/945,871 disclosed above.

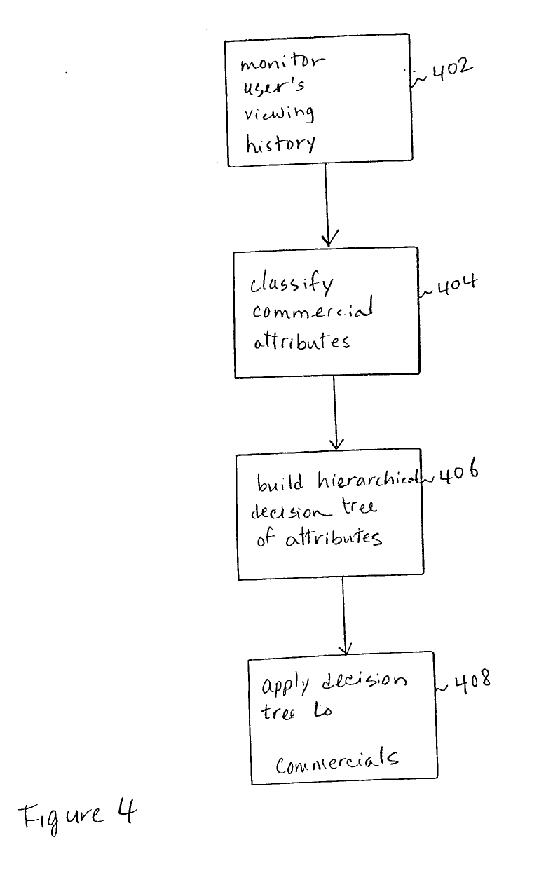

FIG. 4 is a flow diagram illustrating a method for selecting commercials for recommendation. This method recommends commercial programming using decision trees. According to one aspect, inductive principles are utilized to identify a set of recommended commercials that may be of interest to a particular viewer, based on the past viewing history of a user.

At 402, a user's viewing history is monitored and commercials actually watched (positive examples) and those not watched (negative examples) by the user are analyzed. For example, commercials are determined to be watched, if the user stays on the channel when those commercials are being broadcasted as identified according to the methods described above with reference to FIGS. 1 and 2. Commercials are determined to be not watched, if the user changes the channel or mutes the television. Optionally, there may be a camera that detects the user's gaze or presence in the room to determine whether a commercial is being watched. Individual user preferences may be monitored and built during the same time the commercials are being detected and identified.

User's preferences for certain commercials may be determined, for example, at the same time the commercials are identified and stored by types as described with reference to FIGS. 2 and 3. For example, a user profile may be built according to a user's behavior during the broadcasting of the commercial while the commercial is identified and stored. Optionally or additionally, a pre-existing user's viewing history, for example, that was built previously, may be used to determine user's preferences.

For each positive and negative commercial example (i.e., commercials watched and not watched), at 404, a number of commercial attributes are classified in the user profile, such as the duration, type of advertisement, genre of a given commercial, time of day, station call sign (for example, CNBC, CNN, etc), and specific words (dandruff, shampoo, nizoral-d, etc). At 406, the various attributes are then positioned in the hierarchical decision tree based on a ranking of the entropy of each attribute. Each node and sub-node in the decision tree corresponds to a given attribute from the user profile. Each leaf node in the decision tree corresponds to either a positive or negative recommendation for a commercial mounted at the corresponding leaf node. The decision tree attempts to cover as many positive examples as possible but none of the negative examples.

For example, if a given commercial in training data has a duration of more than 30 seconds and advertises household products, the commercial is classified under a leaf node as a positive example. Thereafter, if a commercial in the test data has values meeting this criteria for these duration and type attributes, the commercial is recommended.

At 406, the decision tree is built or trained using a decision tree process that implements a “top-down divide and conquer” approach. The decision tree techniques of the present invention are based on the well-established theory of Ross Quinlan, discussed, for example, in C4.5: Programs for Machine Learning, Morgan Kaufmann Publishers, Palo Alto, Calif. 1990. The decision tree is easily calculated, can be used in real-time and can be extended to any number of classes. The following paragraphs describe the decision tree principle in more detail.

Decision Trees are based on the well-established theory of concept learning developed in the late 1950s by Hunt et. al.. See, for example, Hunt et al., Experiments in Induction, Academic Press, New York (1966). It was further extended and made popular by Breiman et. al. Breiman et al., Classification and Regression Trees, Belmont, Calif. (Wadsworth, 1984); Quinlan J. R., Learning Efficient Classification Procedures and their Application to Chess End Games, Michalski R. S., Carbonell J. G. and Mitchell T. M. (Eds.), in Machine Learning: An Artificial Approach, Vol. 1, Morgan Kaufmann Publishers Inc., Palo Alto, California (1983); Quinlan J. R., Probabilistic Decision Trees, Kodratoff Y. and Michalski R. S. (Eds.), in Machine Learning: An Artificial Approach, Vol. 3, Morgan Kaufmann Publishers Inc., Palo Alto, Calif., (1990); and Quinlan J. R., C4.5: Programs for Machine Learning, Morgan Kaufmann Publishers, Sam Mateo, Calif. (1993).

The basic method for constructing a decision tree is as follows: Let T be a set of training cases, such as commercials preferred and not preferred by a viewer, and let the classes be denoted as {C₁, C₂, . . . , Cₖ}. The following three possibilities exist:

1. T contains one or more cases, all belonging to a single class Cⱼ:

The decision tree for T is a leaf identifying class Cⱼ.

2. T contains no cases:

The decision tree is again a leaf, but the class to be associated with the leaf must be determined from information other than T. For example, the leaf can be chosen with the aid of background knowledge about the domain.

3. T contains cases that belong to a mixture of classes:

In such a case, the approach is to refine T into subsets of cases that seem to be heading towards, single class collection of cases. A test is so chosen, based on a attribute, that has one or more mutually exclusive outcomes {O₁, O₂, . . . , Oₙ}. T is partitioned into subsets T₁, T₂, . . . , Tₙ, where T₁ contains all the cases in T that have outcome O₁ of the chosen outcome. The decision tree for T consists of a decision node identifying the test, and one branch for each possible outcome. The same tree-building approach is applied recursively to each subset of training cases, such that the i-th branch leads to the decision tree constructed from the subset T₁ of training cases.

The tree building process depends on the choice of an appropriate test. Any test that divides T in a nontrivial way, so that at least two of the subsets {Tᵢ} are not empty, will eventually result in a partition into single class subsets, even if all or most of them contain a single training case. However, the objective of the present invention is not to merely build a tree from any partition but to build a tree that reveals the structure of the data set and has predictive power for unseen cases. The test is normally chosen based on gain criterion, based on information theory and explained below.

Considering a hypothetical test with n possible outcomes that partitions the set T of training cases into subsets T₁, T₂, . . . , Tₙ, if this test is to be evaluated without exploring subsequent divisions of the T₁'s, the only information available is the distribution of classes in T and its subsets. Let S be any set of cases and let, freq(C₁, S) denote the number of cases in S that belong to class C₁ and |S| be the number of cases in set S. The information theory that underpins the criterion for selecting the test is as follows: the information conveyed by a message depends on its probability and can be measured in bits as minus the logarithm to base 2 of that probability. As an example, if there are eight equally probable messages, the information conveyed by any one of them is -log₂(⅛) or 3 bits. On selecting one case at random from a set S of cases that belongs to some class Cⱼ, then that message would have a probability of

$$\frac{freq ( {C}_{i} , S )}{\vert S \vert}$$

and the information the message conveys is

$$- {log}_{2} ( \frac{freq ( {C}_{i} , S )}{\vert S \vert} ) bits .$$

In order to find the expected information from such a message pertaining to class membership, a sum over the classes is taken in proportion to their frequencies in S, giving

$$info ( S ) = - {\sum }_{j = 1}^{k} \frac{freq ( {C}_{i} , S )}{\vert S \vert} \times {log}_{2} ( \frac{freq ( {C}_{i} , S )}{\vert S \vert} ) bits .$$

On applying to the set of training cases, info(T) measures the average amount of information needed to identify the class of a case in T. This quantity is often known as the entropy of the set S. When T has been partitioned in accordance with n outcomes of a test X, the expected information can then be found as the weighted sum over the subsets and is given by:

$${info}_{X} ( T ) = {\sum }_{i = 1}^{n} \frac{\vert {T}_{i} \vert}{\vert T \vert} \times info ( {T}_{i} ) .$$

The following quantity:

gain(X)=info(T)−info_{X}(T)

measures the information that is gained by partitioning T in accordance with the test X and is often called as the gain criterion. This criterion, then, selects a test to maximize the information gain commonly referred to as the mutual information between the test X and the class.

Although the gain criterion gives good results, it can have a potentially serious deficiency namely that of having a strong bias in favor of tests with many outcomes. As an example, consider a hypothetical medical diagnostic task in which one of the attributes contains patient identification. Since every such identification is intended to be unique, partitioning the set of training cases on the values of this attribute will lead to a large number of subsets, each containing just one case. As all of these one case subsets would contain cases of a single class, info_{X}(T) would be 0. Thus the information gain from using this attribute to partition the set of training cases is maximal. However, from the point of view of prediction, such a division is of not much use.

The bias inherent in the gain criterion is rectified by normalization wherein the apparent gain attributable to tests with many outcomes is adjusted. If consideration is given to the information content of a message pertaining to a case that indicates not the class to which the case belongs, but to the outcome of the test, analogous to the definition of info(S) is split info(x):

$$split info ( X ) = - {\sum }_{i = 1}^{n} \frac{\vert {T}_{i} \vert}{\vert T \vert} \times {log}_{2} ( \frac{\vert {T}_{i} \vert}{\vert T \vert} ) .$$

This represents the potential information generated by dividing T into n subsets, whereas the information gain measures the information relevant to classification that arises from the same division. Then, the expression

gain ratio(X)=gain(X)/split info(X)

expresses the proportion of information generated by the split. When the split information is small, this ratio is unstable. To avoid this, the gain ratio criterion selects a test to maximize the ratio subject to the constraint that the information gain must be at least as great as the average gain over all tests examined.

The description above for the construction of a decision tree is based on the assumption that the outcome of a test for any case can be determined. However, in reality data is often missing attribute values. This could be because the value is not relevant to a particular case, was not recorded when the data was collected, or could not be deciphered by the subject responsible for entering the data. Such incompleteness is typical of real-world data. There are then generally two choices left: either a significant proportion of available data must be discarded and some test cases pronounced unclassifiable, or the algorithms must be amended to cope with missing attribute values. In most situations, the former is unacceptable as it weakens the ability to find patterns. Modification of the criteria for dealing with missing attribute values can then be realized as follows.

Let T be the training set and X a test based on some attribute A, and suppose that the value of A is known only in a fraction F of the cases in T. info(T) and info_{X}(T) are calculated as before, except that only cases with known values of A are taken into account. The definition of gain can then be amended to:

gain(X)=probability A is known×(info(T)−info_{X}(T))+probability A is not known×0=F×(info(T)−info_{X}(T)).

This definition of gain is nothing but the apparent gain from looking at cases with known values of the relevant attribute, multiplied by the fraction of such cases in the training set. Similarly the definition of split info(X) can also be altered by regarding the cases with unknown values as an additional group. If a test has n outcomes, its split information is computed as if the test divided the cases into n+1 subsets. Using the modified definitions of gain and split info partitioning the training set is achieved in the following way. When a case from T with known outcome O₁ is assigned to subset T₁, the probability of that case belonging in subset Tᵢ is 1 and in all other subsets 0. However, when the outcome is not known, only a weaker probabilistic statement can be made. If the case has a known outcome, this weight is 1; if the case has an unknown outcome, the weight is just the probability of outcome Oᵢ at that point. Each subset T₁ is then a collection of possibly fractional cases so that |Tᵢ| can be re-interpreted as the sum of the fractional weights of the cases in the set. It is possible that the training cases in T might have non-unit weights to start with, since T might be one subset of an earlier partition. In general, a case from T with weight w whose outcome is not known is assigned to each subset T₁ with weight

w×probability of outcome Oᵢ.

The latter probability is estimated as the sum of the weights of cases in T known to have outcome O₁, divided by the sum of the weights of the cases in T with known outcomes on this test.

If the classes are considered to be ‘commercials-watched’ and ‘commercials-not-watched’, then the format of the decision tree is such that, it has nodes and leaves where nodes correspond to a test as described above to be performed and leaves correspond to the two classes. Testing an unknown case (show) now involves in parsing the tree to determine as to which class the unknown case belongs to. However, if at a particular decision node, a situation is encountered wherein the relevant attribute value is unknown, so that the outcome of the test cannot be determined, the system then explores all possible outcomes and combines the resulting classifications. Since there can now be multiple paths from the root of a tree or from the subtree to the leaves, the classification is then a class distribution rather than a single class. When the class distribution for the unseen case has been obtained, the class with the highest probability is assigned as the predicted class.

For each commercial in the database and applying the user's preferences, the decision tree is traversed to classify the commercial into one of the leaf nodes. Based on the assigned leaf node, a given program is either a positive or negative recommendation. Any set of commercials, for example identified from a broadcast, then may be applied to the decision tree for recommending at 408. For example, if it was determined that a viewer prefers a commercial with the following attributes:

Time: 9:00 PM;

Station: CNBC;

Duration: 30 seconds;

Type: fast moving;

Genre: household products;

Specific words: dandruff, shampoo,

a leaf node following the above attribute nodes in a decision tree would have a positive attribute and may also include a ranking, for example, 89%. When applying a commercial to determine whether to recommend that commercial to the viewer, the tree may be used as is or the tree may be decomposed into a set of rules such as:

IF (time>=8:30 PM) AND (duration>15 seconds) AND (genre=household)

THEN

POS [89%].

According to this rule, all commercials that have the descriptive information and user preference information that match the above criteria may be classified as a positive example with a probability of 89%. Since they are classified as positive, they are recommended. Thus, if test data, that is a commercial has attributes such as:

Time: 11:00 PM;

Station: ABC;

Duration: 60 seconds;

type: slow moving;

genre: household product;

specific words: electronics, TV,

this commercial will be recommended since its attribute values satisfy the above rule.

Further details of this method is described in co-pending and co-owned U.S. patent application Ser. No. 09/466,406 disclosed above.

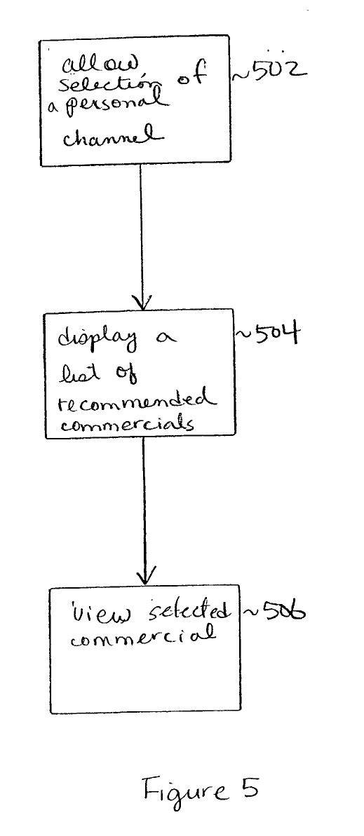

The commercials determined for recommendation for a particular user may then be presented to the user. FIG. 5 is a flow diagram illustrating dynamic channel creation for presenting recommended commercials to users. At 502, a user is enabled to select a personal channel for viewing commercials. For example, the star (*) button on a remote controller may be used to invoke the personal channel mode on a screen. For example, once the decision tree is created and stored for a user locally, pressing the star (*) button may initiate a transfer of commercials from a commercial service. They are applied to the decision tree and the commercials determined for recommendation may be stored for playback.

At 504, the list of commercials selected for recommendation to the viewer is displayed upon a display, for example, the television screen. The viewer then selects a particular commercial that is intended for watching. A recorder on the VCR will automatically be programmed to bring the commercial for viewing upon the screen at 506. Further details of this method is described in co-pending and co-owned U.S. patent application Ser. No. 09/821,059 disclosed above.

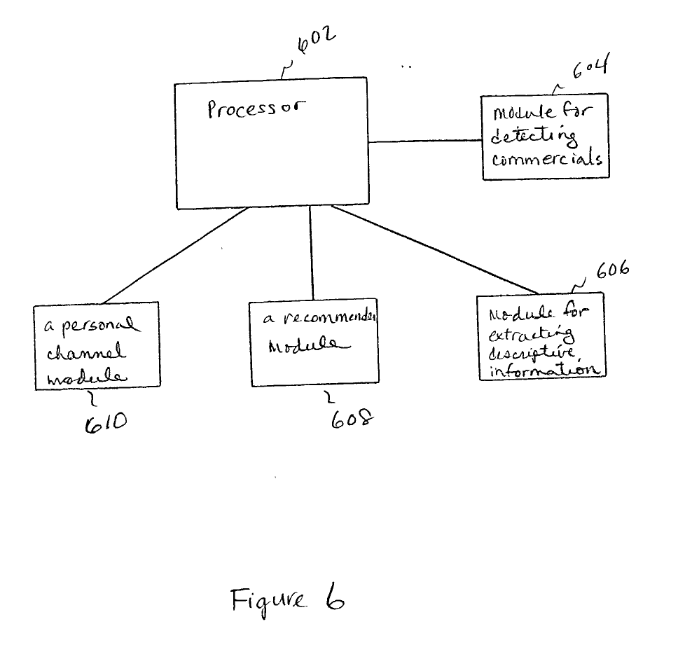

FIG. 6 is a system diagram illustrating the components of the present invention in one aspect. The system for recommending commercials includes a processor 602 that controls a commercial detector module 604 for detecting commercials and a module 606 that extracts descriptive information from the detected commercials as described with reference to FIGS. 2 and 3. The extracted information in the detected commercials are a input to a recommender module 608 that determines which commercials should be recommended to a user as described with reference to FIG. 4 based on the decision tree built as described above. The selected commercials for recommendation are then presented to the user via a dynamic channel creation module 610 as described with reference to FIG. 5.

According to the method described herein, commercials and their types and attributes are identified and viewer's preferences are determined. Using the identified commercials and viewer's preferences, a decision tree is built or trained. The decision tree is then applied to one or more commercials to determine which of these commercials should be recommended to the viewer. The commercials selected for recommendation are then presented to the viewer using a dynamic personal channel. The commercials that are applied to the decision tree for recommendation may be those broadcasted in real time, that is as they are broadcasted. The commercials that are applied to the decision tree for recommendation also may be those already stored or taped, which are then played back to the viewer. Similarly, the commercials that are used to build a decision tree may have already been identified and typed, or alternatively, these commercials may be used to build a decision tree as they are identified from a broadcast. Optionally, a decision tree building may be an on going process where user's preferences may be modified as their preferences are continuously monitored and updated.

While the invention has been described with reference to several embodiments, it will be understood by those skilled in the art that the invention is not limited to the specific forms shown and described. For example, other known methods may be used to extract and identify commercials. Further, other known methods may be used to recommend commercials so identified. Thus, various changes in form and details may be made therein without departing from the spirit and scope of the invention as defined by the appended claims.

What is claimed is:

1. A method for recommending commercials to viewers, comprising:
detecting one or more commercial segments from video signals;
extracting descriptive information from the one or more commercial segments; and
selecting one or more commercials based on the descriptive information for recommendation.

2. The method of claim 1, further including:
providing a personal channel for displaying the selected commercials.

3. The method of claim 1, wherein the detecting includes:
receiving video signals;
extracting one or more identifying features in the video signals; and
identifying a video content based on the extracted features.

4. The method of claim 1, wherein the extracting includes:
analyzing transcript information associated with the commercial segment; and
identifying a type of the commercial segment.

5. The method of claim 4, wherein the extracting further includes:
storing the identified type and the commercial segment.

6. The method of claim 1, further including:
monitoring user's preference to the one or more commercials.

7. The method of claim 1, wherein the selecting includes:
monitoring user's viewing preferences;
classifying one or more commercial attributes;
building a decision tree having the commercial attributes according to the user's viewing preferences; and
applying the decision tree to one or more commercials.

8. The method of claim 7, wherein the applying includes:
applying the decision tree to one or more commercials that are broadcasted.

9. The method of claim 7, wherein the applying includes:
applying the decision tree to one or more commercials that have been stored.

10. The method of claim 2, wherein the providing includes:
allowing a user to select a personal channel;
displaying a list of recommended commercials on the personal channel;
allowing the user to select a commercial from the list; and
allowing the user to view the selected commercial.

11. A system for recommending commercials, comprising:
a processor for controlling a commercial detector module for detecting one or more commercials;
a module for detecting one or more commercials from video signals;
a module for extracting descriptive information from the detected commercials;
a recommender module for selecting commercials to recommend to a user based on the descriptive information; and
a dynamic personal channel module for creating a dynamic channel for presenting selected commercials.

12. A program storage device readable by a machine, tangibly embodying a program of instructions executable by the machine to perform method steps of recommending commercials, comprising:
detecting one or more commercial segments from video signals;
extracting descriptive information from the commercial segment; and
selecting one or more commercials based on the descriptive information for recommendation.

13. The program storage device of claim 12, further including:
providing a personal channel for displaying the selected commercials.
